(19) United States
(12) Patent Application Publication
(10) Pub. No.: US 2021/0018934 A1
(43) Pub. Date: Jan. 21, 2021

(54) TRAVEL CONTROL DEVICE, TRAVEL SYSTEM, AND TRAVEL PROGRAM

(71) Applicant: TOYOTA JIDOSHA KABUSHIKI KAISHA, Toyota-shi (JP)

(72) Inventors: Kohta TARAO, Nagoya-shi (JP); Hiroki AWANO, Nerima-ku (JP); Kuniaki JINNAI, Nagoya-shi (JP); Yoshihiro MAEKAWA, Toyota-shi (JP)

(73) Assignee: TOYOTA JIDOSHA KABUSHIKI KAISHA, Toyota-shi (JP)

(21) Appl. No.: 16/930,854

(22) Filed: Jul. 16, 2020

(30) Foreign Application Priority Data
Jul. 19, 2019 (JP) 2019-133728

(51) Int. Cl. G05D 1/02; H04W 4/46; G08G 1/00; G08G 1/01

(52) U.S. Cl. CPC G05D 1/0295; H04W 4/46; G05D 2201/0213; G08G 1/0133; G05D 1/0276; G08G 1/22

(57) ABSTRACT

A travel control device including a congestion situation acquisition section configured to acquire a currently occurring congestion situation for traveling vehicles or a predicted congestion situation of predicted congestion for traveling vehicles, a vehicle formation acquisition section configured to acquire information relating to a predefined vehicle formation in a traveling state, a communication section configured to communicate with vehicles configuring the vehicle formation, and a switchover control section configured to switch a leading vehicle traveling at a head of the vehicle formation acquired by the vehicle formation acquisition section over to remote driving when the currently occurring congestion situation or the predicted congestion situation has been acquired by the congestion situation acquisition section.

### CROSS-REFERENCE TO RELATED APPLICATION

This application is based upon and claims the benefit of priority of the prior Japanese Patent Application No. 2019-133728, filed on Jul. 19, 2019, the entire contents of which are incorporated herein by reference.

### FIELD

The embodiments discussed herein are related to a travel control device, a travel system, and a travel program.

Patent Document 1 (Japanese Patent Application Laid-Open (JP-A) No. 2000-285398) discloses an automatic following travel system in which a leading vehicle positioned at the head of plural vehicles traveling in convoy is driven by a driver, and each following vehicle positioned behind the leading vehicle travels in convoy by automatically following the leading vehicle. In this automatic following travel system, when convoy travel starts, a travel ECU of the leading vehicle instructs each of the following vehicles to travel in convoy, and a travel ECU of the following vehicle determines whether or not the following vehicle should travel based on instructions from the leading vehicle. The travel ECU of the following vehicle also controls the actions of the following vehicle so as to maintain a substantially constant inter-vehicle distance to another vehicle positioned immediately ahead of the following vehicle.

The automatic following travel system described in Patent Document 1 (JP-A No. 2000-285398) does not give consideration to congestion alleviation in cases in which congestion has occurred or congestion has been predicted. There is accordingly room for improvement in this regard.

### SUMMARY

In consideration of the above circumstances, an object of the present disclosure is to provide a travel control device, a travel system, and a travel program capable of alleviating congestion when plural vehicles are traveling.

A travel control device according to a first aspect of the present disclosure includes: a congestion situation acquisition section configured to acquire a currently occurring congestion situation for traveling vehicles or a predicted congestion situation of predicted congestion for traveling vehicles; a vehicle formation acquisition section configured to acquire information relating to a predefined vehicle formation in a traveling state; a communication section configured to communicate with vehicles configuring the vehicle formation; and a switchover control section configured to switch a leading vehicle traveling at a head of the vehicle formation acquired by the vehicle formation acquisition section over to remote driving when the currently occurring congestion situation or the predicted congestion situation has been acquired by the congestion situation acquisition section.

In the travel control device according to the first aspect, the currently occurring congestion situation or the predicted congestion situation of predicted congestion for traveling vehicles is acquired by the congestion situation acquisition section. The information relating to the predefined vehicle formation in a traveling state is acquired by the vehicle formation acquisition section. Communication between the travel control device and the vehicles configuring the vehicle formation is performed by the communication section. The leading vehicle traveling at the head of the vehicle formation acquired by the vehicle formation acquisition section is switched over to remote driving by the switchover control section when the currently occurring congestion situation or the predicted congestion situation has been acquired by the congestion situation acquisition section. This enables travel of the leading vehicle of the vehicle formation to be rapidly controlled by remote driving when congestion has occurred or when congestion is predicted. For example, by controlling the speed and travel direction of the leading vehicle of the vehicle formation by remote driving, the speed of the leading vehicle is controlled so as be substantially constant, and fluctuations in the travel speeds of plural following vehicles traveling behind the leading vehicle are thereby suppressed. The travel control device thereby enables congestion to be alleviated when plural vehicles are traveling in comparison to cases in which travel of a leading vehicle of a vehicle formation is left to the driver of the leading vehicle.

A travel control device according to a second aspect is the travel control device of the first aspect, further including a storage section configured to store a predetermined situation in which congestion is likely to occur as the predicted congestion situation.

In the travel control device according to the second aspect, the predetermined situation in which congestion is likely to occur is stored in the storage section as the predicted congestion situation. Making an association with the predetermined situation in which congestion is likely to occur enables the congestion situation acquisition section to acquire the predicted congestion situation at an early stage.

A travel control device according to a third aspect is the travel control device of the second aspect, wherein a predetermined disaster is stored in the storage section as the predetermined situation.

In the travel control device according to the third aspect, the predetermined disaster is stored in the storage section as the predetermined situation in which congestion is likely to occur. Making an association with the predetermined disaster enables the congestion situation acquisition section to acquire the predicted congestion situation at an early stage.

A travel control device according to a fourth aspect is the travel control device of the second aspect, wherein a predetermined location where congestion is likely to occur and a time when congestion is likely to occur are stored in the storage section as the predetermined situation.

In the travel control device according to the fourth aspect, the predetermined location where congestion is likely to occur and the time when congestion is likely to occur are stored in the storage section as the predetermined situation in which congestion is likely to occur. Making an association with the predetermined location where congestion is likely to occur and the time when congestion is likely to occur enables the congestion situation acquisition section to acquire the predicted congestion situation at an early stage.

A travel control device according to a fifth aspect is the travel control device of the first aspect, further including an autonomous driving switchover control section configured to switch plural following vehicles traveling behind the leading vehicle in the vehicle formation over to autonomous driving.

In the travel control device according to the fifth aspect, each of the plural following vehicles traveling behind the leading vehicle in the vehicle formation is switched over to autonomous driving by the autonomous driving switchover control section. This for example enables the plural following vehicles traveling behind the leading vehicle to made to travel by autonomous driving so as to maintain a substantially constant distance from the vehicle in front. This enables congestion to be more reliably alleviated when plural vehicles are traveling.

A travel system according to a sixth aspect includes the travel control device of the first aspect, a remote center configured to transmit control information for performing remote driving to the leading vehicle traveling at the head of the vehicle formation, and a remote driving control section provided at the leading vehicle in order to execute the remote driving based on the control information received from the remote center.

In the travel system according to the sixth aspect, the control information for performing remote driving is transmitted from the remote center to the leading vehicle in the vehicle formation. The remote driving is executed by the remote driving control section of the leading vehicle based on the control information received from the remote center. For example, by controlling the speed and travel direction of the leading vehicle of the vehicle formation by remote driving, the speed of the leading vehicle is controlled so as be substantially constant, and fluctuations in the travel speeds of plural following vehicles traveling behind the leading vehicle are thereby suppressed. The travel control device thereby enables congestion to be alleviated when plural vehicles are traveling in comparison to cases in which travel of a leading vehicle of a vehicle formation is left to the driver of the leading vehicle.

A travel system according to a seventh aspect includes the travel control device of the fifth aspect, a remote center configured to transmit control information for performing remote driving to the leading vehicle traveling at the head of the vehicle formation, a remote driving control section provided at the leading vehicle in order to execute the remote driving based on the control information received from the remote center, and an autonomous driving control section provided at a given vehicle of the plurality of following vehicles to control acceleration, deceleration, and steering of the given vehicle by communicating with other vehicles configuring the vehicle formation.

In the travel system according to the seventh aspect, the control information for performing remote driving is transmitted from the remote center to the leading vehicle of the vehicle formation. The remote driving control section of the leading vehicle executes remote driving based on the control information received from the remote center. In the following vehicles traveling behind the leading vehicle of the vehicle formation, the autonomous driving control section controls acceleration, deceleration, and steering of the given vehicle by communicating with the other vehicles configuring the vehicle formation. Thus, for example, by controlling the speed and travel direction of the leading vehicle of the vehicle formation by remote driving, the speed of the leading vehicle is controlled so as be substantially constant. Furthermore, for example, the plural following vehicles traveling behind the leading vehicle are controlled by autonomous driving such that the speed of each given vehicle is substantially constant. This enables congestion to be more reliably alleviated when plural vehicles are traveling in comparison to cases in which travel of a leading vehicle and following vehicles in a vehicle formation is left to the drivers of the respective vehicles.

A travel system according to an eighth aspect is the travel system of the sixth aspect, wherein a vehicle formation detection section configured to detect the vehicle formation is provided at a road on which the vehicles are traveling. The vehicle formation acquisition section is configured to acquire information relating to the vehicle formation derived from a detection signal detected by the vehicle formation detection section.

In the travel system according to the eighth aspect, the vehicle formation in a traveling state is detected by the vehicle formation detection section provided to the road where the vehicles are traveling. The vehicle formation acquisition section acquires information relating to the vehicle formation derived from the detection signal detected by the vehicle formation detection section, thereby enabling information relating to the vehicle formation in a traveling state to be acquired at an early stage.

A travel system according to a ninth aspect is the travel system of the sixth aspect, wherein a congestion detection section configured to detect the currently occurring congestion situation is provided at a road on which the vehicles are traveling. The congestion situation acquisition section is configured to acquire the currently occurring congestion situation derived from a detection signal detected by the congestion detection section.

In the travel system according to the ninth aspect, the currently occurring congestion situation is detected by the congestion detection section provided to the road on which the vehicles are traveling. The congestion situation acquisition section acquires the currently occurring congestion situation derived from the detection signal detected by the congestion detection section, thereby enabling the currently occurring congestion situation of the traveling vehicles to be acquired at an early stage.

A travel system according to a tenth aspect is the travel system of the sixth aspect, wherein the vehicle formation acquisition section is configured to acquire information relating to the vehicle formation from environmental information acquired by communication between the plural traveling vehicles.

In the travel system according to the tenth aspect, the vehicle formation acquisition section acquires the information relating to the vehicle formation from the environmental information acquired from communication between the plural traveling vehicles, thereby enabling the information relating to the predefined vehicle formation in a traveling state to be acquired at an early stage. Moreover, there is no need to provide a vehicle formation detection section or the like to the road, enabling costs to be reduced.

A travel system according to a eleventh aspect is the travel system of the sixth aspect, wherein the congestion situation acquisition section is configured to acquire the currently occurring congestion situation from environmental information acquired by communication between the plural traveling vehicles.

In the travel system according to the eleventh aspect, the congestion situation acquisition section acquires the currently occurring congestion situation from the environmental information acquired from communication between the plural traveling vehicles, thereby enabling the currently occurring congestion situation of the traveling vehicles to be acquired at an early stage. Moreover, there is no need to provide a congestion detection section or the like to the road, enabling costs to be reduced.

A travel program according to a twelfth aspect causes a computer to execute processing, the processing including a step of acquiring a currently occurring congestion situation for traveling vehicles or a predicted congestion situation of predicted congestion for traveling vehicles, a step of acquiring information relating to a predefined vehicle formation in a traveling state, and a step of switching a leading vehicle traveling at a head of the vehicle formation over to remote driving when the currently occurring congestion situation or the predicted congestion situation has been acquired.

A travel control device according to a thirteenth aspect includes memory and a processor connected to the memory. The processor is configured to acquire a currently occurring congestion situation for traveling vehicles or a predicted congestion situation of predicted congestion for traveling vehicles, acquire information relating to a predefined vehicle formation in a traveling state, and switch a leading vehicle traveling at a head of the vehicle formation over to remote driving when the currently occurring congestion situation or the predicted congestion situation has been acquired.

A travel control method according to a fourteenth aspect includes a process of acquiring a currently occurring congestion situation for traveling vehicles or a predicted congestion situation of predicted congestion for traveling vehicles, a process of acquiring information relating to a predefined vehicle formation in a traveling state, and a process of switching a leading vehicle traveling at a head of the vehicle formation over to remote driving when the currently occurring congestion situation or the predicted congestion situation has been acquired.

The vehicle controller device of the present disclosure enables congestion to be alleviated when plural vehicles are traveling.

### BRIEF DESCRIPTION OF DRAWINGS

Exemplary embodiments of the present disclosure will be described in detail with reference to the following figures, wherein:

FIG. 1 is a diagram illustrating a schematic configuration of a travel system according to a first exemplary embodiment;

FIG. 2 is a block diagram illustrating hardware configuration of equipment installed in a vehicle;

FIG. 3 is a block diagram illustrating an example of functional configuration of a vehicle;

FIG. 4 is a block diagram illustrating hardware configuration of a server device;

FIG. 5 is a block diagram illustrating an example of functional configuration of a server device;

FIG. 6 is a block diagram illustrating hardware configuration of a remote operation station;

FIG. 7 is a block diagram illustrating an example of functional configuration of a remote operation station;

FIG. 8 is a flowchart illustrating a flow of travel processing by a vehicle controller device;

FIG. 9 is a flowchart illustrating a flow of travel processing by a server device;

FIG. 10 is a diagram illustrating a state in which plural vehicles are traveling along a road as viewed looking down from above;

FIG. 11 is a diagram illustrating a schematic configuration of a travel system according to a second exemplary embodiment;

FIG. 12 is a block diagram illustrating hardware configuration of a detection device;

FIG. 13 is a block diagram illustrating an example of functional configuration of a detection device;

FIG. 14 is a flowchart illustrating a flow of travel processing by a detection device; and

FIG. 15 is a flowchart illustrating a flow of travel processing by a server device.

### DESCRIPTION OF EMBODIMENTS

Explanation follows regarding an example of exemplary embodiments of the present disclosure, with reference to the drawings. Note that identical or equivalent configuration elements and portions are allocated the same reference numerals in each of the drawings.

### First Exemplary Embodiment

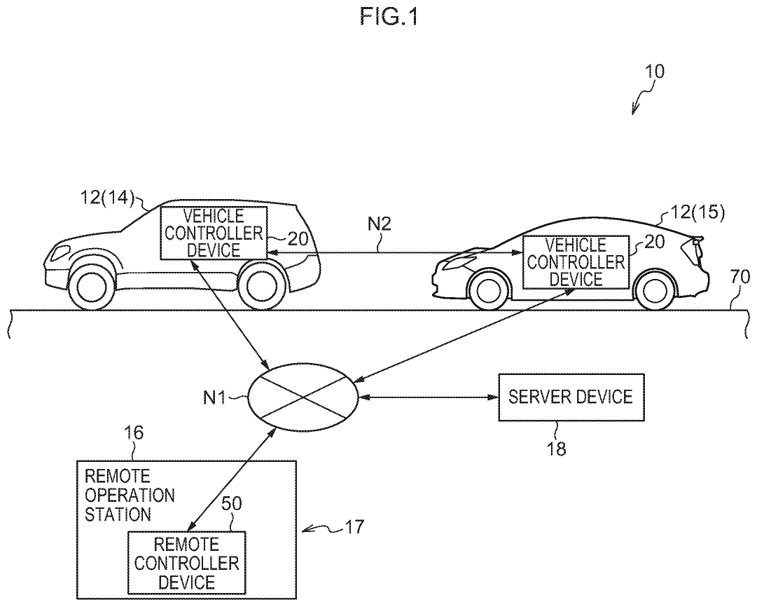

FIG. 1 is a diagram illustrating a schematic configuration of a travel system according to a first exemplary embodiment.

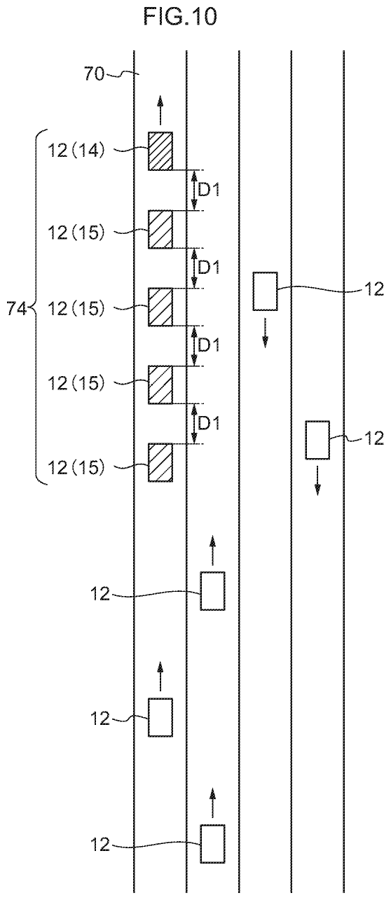

As illustrated in FIG. 1, a travel system 10 is configured including plural vehicles 12, a remote operation station 16 provided at a remote center 17, and a server device 18. The plural vehicles 12 include a leading vehicle 14 traveling at the head of a predefined vehicle formation 74 (see FIG. 10), and following vehicles 15 traveling behind the leading vehicle 14.

In the first exemplary embodiment, explanation will be given regarding an example in which the plural vehicles 12 are traveling along a road 70 in the same direction, as illustrated in FIG. 1. Although the leading vehicle 14 and the following vehicle 15 are indicated by different reference numerals in FIG. 1, the leading vehicle 14 and the following vehicle 15 are referred to collectively as the “vehicles 12” when no distinction is being made therebetween.

The leading vehicle 14 and each of the following vehicles 15 include a vehicle controller device 20. The remote operation station 16 includes a remote controller device 50. In the travel system 10, the vehicle controller device 20 of the leading vehicle 14, the vehicle controller device 20 of each of the following vehicles 15, the remote controller device 50 of the remote operation station 16, and the server device 18 are connected to one another through a network N1. The respective vehicle controller devices 20 are also capable of communicating directly with one another using vehicle-to-vehicle communication N2. The server device 18 is an example of a travel control device.

Although FIG. 1 only illustrates the leading vehicle 14 and the following vehicle 15 traveling behind the leading vehicle 14 out of the plural vehicles 12 in the vehicle formation 74 (see FIG. 10), in reality plural of the following vehicles 15 (see FIG. 10) are present traveling behind this following vehicle 15. Although the travel system 10 illustrated in FIG. 1 is configured by a single remote operation station 16 and a single server device 18, the travel system 10 may include two or more of both the remote operation stations 16 and the server devices 18.

Each of the vehicles 12 is capable of executing autonomous driving in which independent travel is executed based on a travel plan generated by their vehicle controller device 20, remote driving (namely remotely-operated driving) based on operation by a remote driver serving as a remote driving operator at the remote operation station 16, and manual driving based on operation by an occupant of the vehicle 12 (namely, a driver).

Vehicles

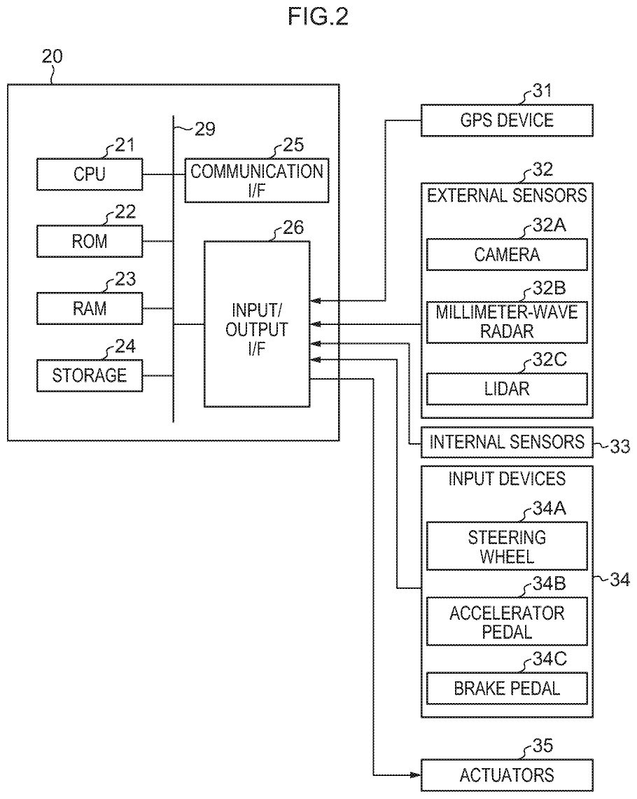

FIG. 2 is a block diagram illustrating hardware configuration of equipment installed in each of the vehicles 12. Note that in the first exemplary embodiment, the leading vehicle 14 and the following vehicles 15 configuring the vehicles 12 are configured similarly to each other. As illustrated in FIG. 2, in addition to the vehicle controller device 20 mentioned previously, each of the vehicles 12 includes a global positioning system (GPS) device 31, external sensors 32, internal sensors 33, input devices 34, and actuators 35.

The vehicle controller device 20 includes a central processing unit (CPU; a processor) 21, read only memory (ROM) 22, random access memory (RAM) 23, storage 24, a communication interface (I/F) 25, and an input/output I/F 26. The CPU 21, the ROM 22, the RAM 23, the storage 24, the communication I/F 25, and the input/output I/F 26 are connected together so as to be capable of communicating with each other through a bus 29.

The CPU 21 is a central processing unit that executes various programs and controls various sections. The CPU 21 reads a program from the ROM 22 or the storage 24 and executes the program, using the RAM 23 as a workspace. The CPU 21 controls the various configurations and performs various arithmetic processing based on the program recorded in the ROM 22 or the storage 24. In the first exemplary embodiment, a travel program is held in the ROM 22 or the storage 24.

The ROM 22 holds various programs and various data. The RAM 23 serves as a workspace to temporarily store the programs or data.

The storage 24 is configured by a hard disk drive (HDD) or a solid state drive (SSD), and stores various programs including an operating system, as well as various data.

The communication I/F 25 includes an interface to connect to the network N1 in order to communicate with the other vehicle controller devices 20, the remote controller device 50, the server device 18, and so on. A communication protocol such as LTE or Wi-Fi (registered trademark in Japan) is employed for this interface. The communication I/F 25 also includes a wireless device to communicate directly with the other vehicle controller devices 20 using the vehicle-to-vehicle communication N2 that employs dedicated short range communications (DSRC) or the like.

The communication I/F 25 acquires travel information relating to other vehicles 12 in the surroundings of the vehicle 12 through the vehicle-to-vehicle communication N2. The travel information includes a travel direction and travel speed of each of the other vehicles 12, the distance to each of the other vehicles 12, and the like.

The input/output I/F 26 is an interface for communicating with the various devices installed in the vehicle 12. In the vehicle controller device 20, the GPS device 31, the external sensors 32, the internal sensors 33, the input devices 34, and the actuators 35 are connected through the input/output I/F 26. Note that the GPS device 31, the external sensors 32, the internal sensors 33, the input devices 34, and the actuators 35 may be directly connected to the bus 29.

The GPS device 31 is a device for measuring the current position of the vehicle 12. The GPS device 31 includes an antenna (not illustrated in the drawings) to receive signals from GPS satellites.

The external sensors 32 are a group of sensors that detect environmental information relating to the periphery of the vehicle 12. The external sensors 32 include a camera 32A that captures a predetermined range, millimeter-wave radar 32B that transmits scanning waves over a predetermined range and picks up reflected waves, and laser imaging detection and ranging (LIDAR) 32C that scans a predetermined range. Note that plural of the cameras 32A may be provided. In such cases, a first camera 32A may image forward from the vehicle 12 while a second camera 32A images rearward from the vehicle 12. Configuration may be made in which one of the plural cameras 32A is a visible light camera and another of the plural cameras 32A is an infrared camera.

The internal sensors 33 are a group of sensors that detect travel states of the vehicle 12. The internal sensors 33 include at least one out of a vehicle speed sensor, an acceleration sensor, and a yaw rate sensor.

The input devices 34 are a group of switches to be operated by an occupant on board the vehicle 12. The input devices 34 include a steering wheel 34A serving as a switch to steer the steered wheels of the vehicle 12, an accelerator pedal 34B serving as a switch to cause the vehicle 12 to accelerate, and a brake pedal 34C serving as a switch to cause the vehicle 12 to decelerate.

The actuators 35 include a steering wheel actuator to drive the steered wheels of the vehicle 12, an accelerator actuator to control acceleration of the vehicle 12, and a brake actuator to control deceleration of the vehicle 12.

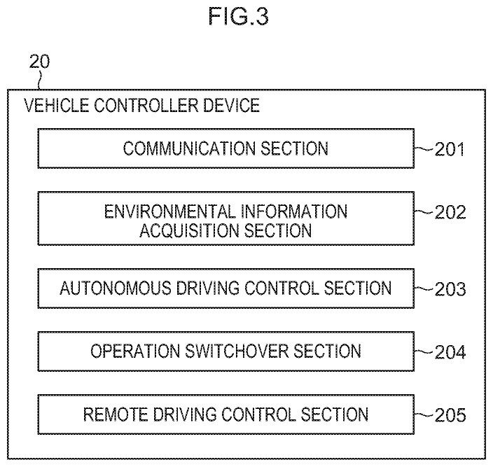

FIG. 3 is a block diagram illustrating an example of functional configuration of the vehicle controller device 20.

As illustrated in FIG. 3, the vehicle controller device 20 includes a communication section 201, an environmental information acquisition section 202, an autonomous driving control section 203, an operation switchover section 204, and a remote driving control section 205. The communication section 201, the environmental information acquisition section 202, the autonomous driving control section 203, the operation switchover section 204, and the remote driving control section 205 are implemented by the CPU 21 reading and executing the travel program stored in the ROM 22 or the storage 24.

The communication section 201 communicates with the other vehicles 12 in the vehicle formation 74 (see FIG. 10), communicates with the server device 18, and also communicates with the remote operation station 16.

The environmental information acquisition section 202 acquires environmental information relating to the periphery of the vehicle 12. The environmental information acquisition section 202 acquires environmental information relating to the periphery of the vehicle 12 from the external sensors 32 through the input/output I/F 26. The environmental information acquisition section 202 also receives environmental information relating to the surroundings of the vehicle 12 through the vehicle-to-vehicle communication N2. The environmental information includes not only other vehicles 12 traveling peripherally to the vehicle 12, pedestrians, and the like, but also information relating to the weather, brightness, road width, obstacles, and the like. The environmental information also includes information such as the travel directions and travel speeds of the other vehicles 12 traveling periphery to the vehicle 12 and the distances between the plural vehicles 12. The environmental information also includes meteorological information relating to temperature, wind speed, precipitation amounts, and the like, earthquake information relating to seismic intensity, tsunamis, and the like, and traffic information relating to congestion, accidents, roadworks, and the like.

The autonomous driving control section 203 creates a travel plan and controls autonomous driving of the vehicle 12 when traveling independently based on this travel plan. The autonomous driving control section 203 controls the autonomous driving of the vehicle 12 based on the environmental information acquired by the environmental information acquisition section 202, the position information of the vehicle 12 acquired by the GPS device 31, the travel information of the vehicle 12 acquired by the internal sensors 33, and the like. In the first exemplary embodiment, each of the following vehicles 15 traveling to the rear of the leading vehicle 14 of the vehicles 12 configuring the vehicle formation 74 (see FIG. 10) acquires travel information from the other vehicles 12 (including the leading vehicle 14, for example) in the surroundings of the following vehicle 15 through the vehicle-to-vehicle communication N2. The autonomous driving control section 203 controls acceleration, deceleration, and steering of the following vehicle 15 based on this information. The travel information includes, for example, information relating to the travel directions and travel speeds of the other vehicles 12, and the distances of the other vehicles 12 from the following vehicle 15.

The operation switchover section 204 switches over to any driving mode out of manual driving, autonomous driving, or remote driving based on input signals relating to the driving mode. Driving mode switching by the operation switchover section 204 includes cases in which switching is performed in response to an occupant of the vehicle 12 inputting (including selecting, for example) a driving mode, as well as cases in which switching to remote driving is performed based on a switchover signal from the remote operation station 16. Driving mode switching by the operation switchover section 204 may also include switching over to autonomous driving based on a switchover signal from the server device 18.

The remote driving control section 205 executes remote driving of the vehicle 12 based on control information for performing remote driving received from the remote operation station 16. In the first exemplary embodiment, control information for performing remote driving is transmitted to the leading vehicle 14 of the vehicle formation 74 (see FIG. 10) from the remote operation station 16, and the leading vehicle 14 executes remote driving.

Server Device

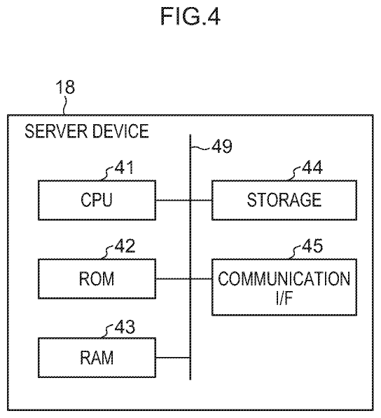

FIG. 4 is a block diagram illustrating hardware configuration of equipment installed in the server device 18.

As illustrated in FIG. 4, the server device 18 is configured including a CPU 41, ROM 42, RAM 43, storage 44, and a communication I/F 45. The CPU 41, the ROM 42, the RAM 43, the storage 44, and the communication I/F 45 are connected together so as to be capable of communicating with each other through a bus 49.

The CPU 41 is a central processing unit that executes various programs and controls various sections. The CPU 41 reads a program from the ROM 42 or the storage 44 and executes the program, using the RAM 43 as a workspace. The CPU 41 controls the various configurations and performs various arithmetic processing based on the program recorded in the ROM 42 or the storage 44. In the first exemplary embodiment, a travel program is held in the ROM 42 or the storage 44.

The ROM 42 holds various programs and various data. The RAM 43 serves as a workspace to temporarily store the programs or data.

The storage 44 is configured by a hard disk drive (HDD) or a solid state drive (SSD), and stores various programs including an operating system, as well as various data.

The communication I/F 45 includes an interface to connect to the network N1 in order to communicate with the plural vehicle controller devices 20, the remote controller device 50, and so on. A communication protocol such as LTE or Wi-Fi (registered trademark in Japan) is employed for this interface.

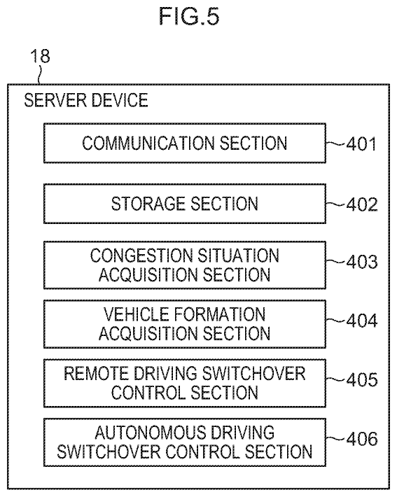

FIG. 5 is a block diagram illustrating an example of functional configuration of the server device 18.

As illustrated in FIG. 5, the server device 18 includes a communication section 401, a storage section 402, a congestion situation acquisition section 403, a vehicle formation acquisition section 404, a remote driving switchover control section 405, and an autonomous driving switchover control section 406. The remote driving switchover control section 405 is an example of a switchover control section. The communication section 401, the storage section 402, the congestion situation acquisition section 403, the vehicle formation acquisition section 404, the remote driving switchover control section 405, and the autonomous driving switchover control section 406 are implemented by the CPU 41 reading and executing the travel program stored in the ROM 42 or the storage 44.

The communication section 401 communicates with the plural vehicles 12 and also communicates with the remote operation station 16. The communication section 401 receives the environmental information relating to the peripheries of the plural vehicles 12. The communication section 401 receives the environmental information from the plural vehicles 12 over the network N1.

The storage section 402 stores predetermined situations in which congestion is likely to occur. Examples of the predetermined situations include predetermined disasters, predetermined locations where congestion is likely to occur, and times when congestion is likely to occur. Examples of the predetermined disasters include natural disasters such as meteorological disasters and terrestrial disasters, and man-made disasters such as traffic accidents and fires. Meteorological disasters include floods, heavy snow, tornadoes, thick fog, thunder, and the like. Terrestrial disasters include earthquakes, tsunamis, landslides, volcanic eruptions, and the like. Predetermined locations where congestion is likely to occur include information such as arterial routes, intersections with five or more exits, and single-lane roads. Times when congestion is likely to occur include commuting hours.

The congestion situation acquisition section 403 acquires a currently occurring congestion situation for the traveling vehicles 12, or a predicted congestion situation of predicted congestion for the traveling vehicles 12, based on the environmental information received by the communication section 401. In the first exemplary embodiment, the predicted congestion situation is acquired by predicting congestion associated with the predetermined situations in which congestion is likely to occur stored in the storage section 402.

The vehicle formation acquisition section 404 acquires information relating to the predefined vehicle formation 74 (see FIG. 10) occurring due to the plural vehicles 12 in traveling states, based on the environmental information received by the communication section 401. The vehicle formation acquisition section 404 acquires information relating to the predefined vehicle formation 74 (see FIG. 10) that is in a traveling state. The vehicle formation 74 is, for example, a chain of the vehicles 12 traveling within predetermined inter-vehicle distances of each other.

The remote driving switchover control section 405 controls switching of the vehicles 12 to remote driving. The remote driving switchover control section 405 outputs a switchover signal to the vehicle controller device 20 of the vehicle 12 in order to switch over from autonomous driving or manual driving to remotely-operated driving. In the first exemplary embodiment, in cases in which a currently occurring congestion situation or a predicted congestion situation has been acquired by the congestion situation acquisition section 403, control is performed such that the leading vehicle 14 traveling at the head of the vehicle formation acquired by the vehicle formation acquisition section 404 switches over to remote driving.

The autonomous driving switchover control section 406 controls switching of the vehicles 12 to autonomous driving. The autonomous driving switchover control section 406 outputs a switchover signal to the vehicle controller device 20 of the vehicle 12 in order to switch over from manual driving or remotely-operated driving to autonomous driving. In the first exemplary embodiment, in cases in which the currently occurring congestion situation or predicted congestion situation has been acquired by the congestion situation acquisition section 403, control is performed such that each of the plural following vehicles 15 traveling behind the leading vehicle 14 of the vehicle formation 74 (see FIG. 10) acquired by the vehicle formation acquisition section 404 switches over to autonomous driving.

Remote Operation Station

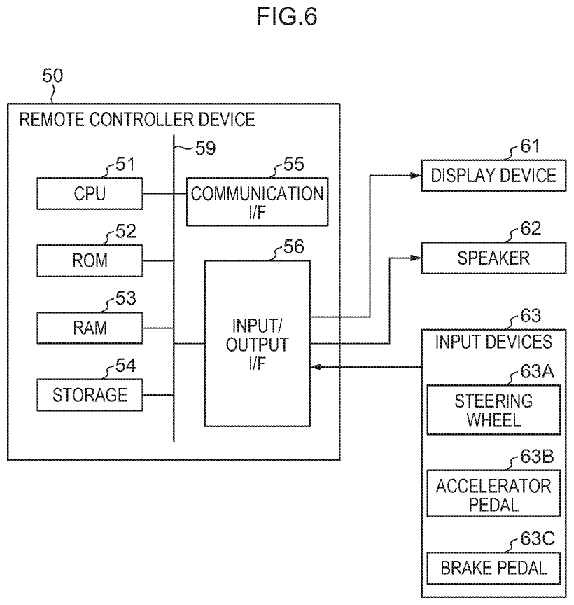

FIG. 6 is a block diagram illustrating hardware configuration of equipment installed in the remote operation station 16. In addition to the remote controller device 50 mentioned above, the remote operation station 16 also includes a display device 61, a speaker 62, and input devices 63.

The remote controller device 50 is configured including a CPU 51, ROM 52, RAM 53, storage 54, a communication I/F 55, and an input/output I/F 56. The CPU 51, the ROM 52, the RAM 53, the storage 54, the communication I/F 55, and the input/output I/F 56 are connected together so as to be capable of communicating with each other through a bus 59. Functionality of the CPU 51, the ROM 52, the RAM 53, the storage 54, the communication I/F 55, and the input/output I/F 56 matches that of the CPU 21, the ROM 22, the RAM 23, the storage 24, the communication I/F 25, and the input/output I/F 26 of the vehicle controller device 20 previously described.

The CPU 51 reads a program from the ROM 52 or the storage 54, and executes the program, using the RAM 53 as a workspace. In the first exemplary embodiment, a travel program is stored in the ROM 52.

The display device 61, the speaker 62, and the input devices 63 are connected to the remote controller device 50 of the first exemplary embodiment through the input/output I/F 56. Note that the display device 61, the speaker 62, and the input devices 63 may be directly connected to the bus 59.

The display device 61 is a liquid crystal monitor for displaying an image captured by the camera 32A of a corresponding vehicle 12 and various information relating to the vehicle 12.

The speaker 62 is a speaker for replaying audio recorded by a microphone (not illustrated in the drawings) attached to the camera 32A of the vehicle 12 together with the captured image.

The input devices 63 are controllers to be operated by a remote driver serving as a remote driving operator using the remote operation station 16. The input devices 63 include a steering wheel 63A serving as a switch to steer the steered wheels of the vehicle 12, an accelerator pedal 63B serving as a switch to cause the vehicle 12 to accelerate, and a brake pedal 63C serving as a switch to cause the vehicle 12 to decelerate. Note that the modes of the respective input devices 63 are not limited thereto. For example, a lever switch may be provided instead of the steering wheel 63A. As another example, push button switches or lever switches may be provided instead of the pedal switches of the accelerator pedal 63B and the brake pedal 63C.

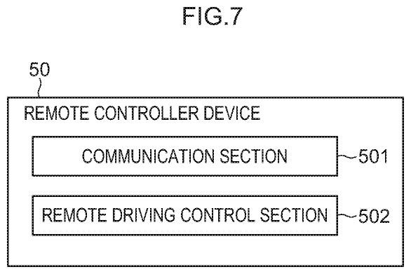

FIG. 7 is a block diagram illustrating an example of functional configuration of the remote controller device 50.

As illustrated in FIG. 7, the remote controller device 50 includes a communication section 501 and a remote driving control section 502.

The communication section 501 communicates with the vehicle 12 that is being remotely driven (for example the leading vehicle 14 in the first exemplary embodiment), and also communicates with the server device 18. The communication section 501 receives captured images and audio from the camera 32A, as well as vehicle information such as the vehicle speed, transmitted from the vehicle controller device 20. The received captured images and vehicle information are displayed on the display device 61, and the audio information is output through the speaker 62.

In cases in which remotely-operated driving is being performed based on operation by a remote driver, the remote driving control section 502 transmits control information for performing remote driving to the vehicle controller device 20 through the communication section 501 based on signals input from the various input devices 63 to control remote driving of the vehicle 12.

Control Flow

Explanation follows regarding operation of the travel system 10. Note that operation is explained in order of time, such that operation of the vehicle controller device 20 of a vehicle 12 is followed by operation of the server device 18.

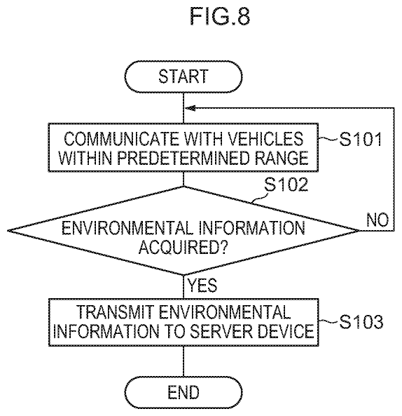

FIG. 8 is a flowchart illustrating a flow of travel processing by the vehicle controller device 20. The CPU 21 reads the travel program from the ROM 22 or the storage 24, expands the travel program in the RAM 23, and executes the travel program in order to perform the travel processing.

When a driver of the vehicle 12 starts driving, at step S101 the CPU 21 communicates with any other vehicles 12 traveling within a predetermined range of the vehicle 12.

At step S102, the CPU 21 determines whether or not environmental information relating to the surroundings of the vehicle 12 has been acquired. The environmental information relating to the surroundings of the vehicle 12 is acquired by communication between the vehicle 12 and other vehicles 12, or by the external sensors 32 provided to the vehicle 12.

In cases in which environmental information has not been acquired (namely, when step S102: NO), the CPU 21 returns to the processing of step S101. In cases in which environmental information has been acquired (namely, when step S102: YES), at step S103 the CPU 21 transmits the environmental information relating to the surroundings of the vehicle 12 to the server device 18. The CPU 21 then ends the processing based on the travel program.

FIG. 8 illustrates an example of a single vehicle 12 in a traveling state. As illustrated in FIG. 10, in cases in which plural of the vehicles 12 are traveling along the road 70, environmental information from each of the plural vehicles 12 is transmitted to the server device 18.

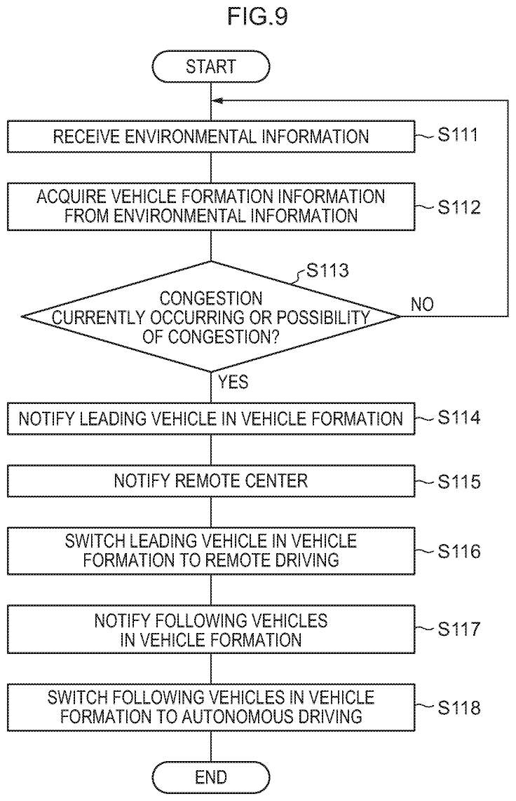

FIG. 9 is a flowchart illustrating a flow of travel processing by equipment installed in the server device 18. The CPU 41 reads the travel program from the ROM 42 or the storage 44, expands the travel program in the RAM 43, and executes the travel program in order to perform the travel processing.

At step S111, the CPU 41 receives environmental information relating to the surroundings of the vehicle 12 in a traveling state. As illustrated in FIG. 10, in cases in which plural of the vehicles 12 are traveling along the road 70, the CPU 41 receives environmental information relating to the surroundings of each of the plural vehicles 12.

At step S112, the CPU 41 acquires information relating to the predefined vehicle formation 74 from the environmental information received at step S111.

At step S113, the CPU 41 determines whether or not congestion is currently occurring or there is a possibility of congestion from the environmental information and the information relating to the vehicle formation 74. The currently occurring congestion situation or the predicted congestion situation is thus acquired.

In cases in which congestion is currently occurring or there is a possibility of congestion (namely, when step S113: YES), at step S114 the CPU 41 notifies the leading vehicle 14 configuring the vehicle formation 74 of the currently occurring congestion situation or the predicted congestion situation. The server device 18 notifies the leading vehicle 14 over the network N1. In cases in which congestion is not currently occurring and there is no possibility of congestion (namely, when step S113: NO), the CPU 41 returns to the processing of step S111.

At step S115, the CPU 41 notifies the remote operation station 16 provided at the remote center 17 of the currently occurring congestion situation or predicted congestion situation. The server device 18 notifies the remote operation station 16 over the network N1.

At step S116, the CPU 41 switches the leading vehicle 14 configuring the vehicle formation 74 over to remote driving. Remote driving of the leading vehicle 14 by the remote operation station 16 is thus started.

At step S117, the CPU 41 notifies each of the following vehicles 15 traveling behind the leading vehicle 14 in the vehicle formation 74 of the currently occurring congestion situation or predicted congestion situation.

At step S118, the CPU 41 switches each of the following vehicles 15 traveling behind the leading vehicle 14 in the vehicle formation 74 over to autonomous driving. Autonomous driving of the following vehicles 15 is thus started. After the processing of step S118, the CPU 41 ends the processing based on the travel program.

As illustrated in FIG. 10, in cases in which information relating to the vehicle formation 74 traveling along the road 70 has been acquired, the leading vehicle 14 of the vehicle formation 74 is remotely driven from the remote operation station 16, and the following vehicles 15 traveling behind the leading vehicle 14 are driven autonomously. For example, the speed and travel direction of the leading vehicle 14 are controlled by remote driving such that the leading vehicle 14 is controlled so as to maintain a substantially constant speed. Moreover, the plural following vehicles 15 traveling behind the leading vehicle 14 travel by autonomous driving so as to maintain a substantially uniform distance from the vehicle 12 in front (for example the leading vehicle 14 or another following vehicle 15). Accordingly, a distance D1 between the leading vehicle 14 and the following vehicle 15 immediately behind, and a distance D1 between following vehicles 15 to the front and rear of each other are maintained so as to be substantially uniform. The travel system 10 of the first exemplary embodiment thereby enables congestion to be alleviated when plural vehicles 12 are traveling in comparison to cases in which travel of a leading vehicle and travel of each of the following vehicles in a vehicle formation is left to the drivers of the respective vehicles.

### Second Exemplary Embodiment

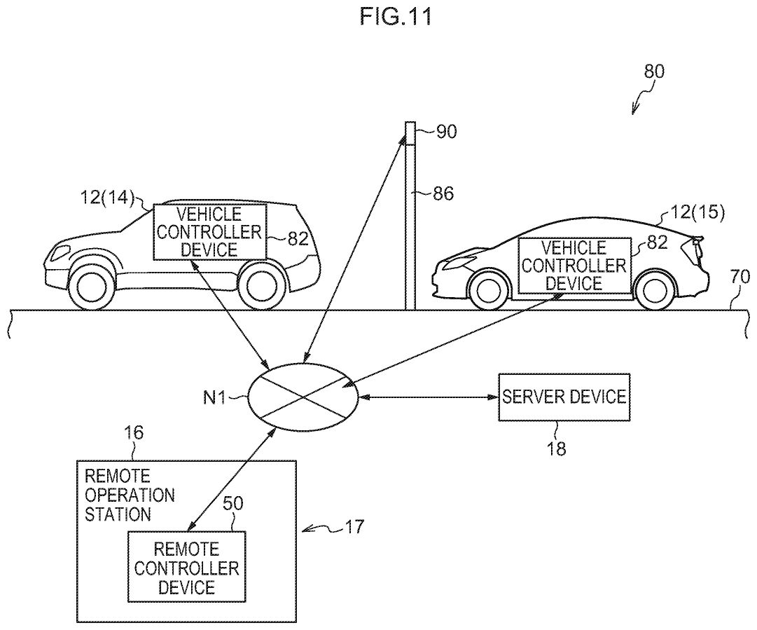

FIG. 11 is a diagram illustrating a schematic configuration of a travel system according to a second exemplary embodiment. Configuration elements equivalent to those of the first exemplary embodiment described above are allocated the same reference numerals, and explanation thereof is omitted.

As illustrated in FIG. 11, a travel system 80 is configured including plural of the vehicles 12, the remote operation station 16 provided at the remote center 17, the server device 18, and a detection device 90 provided to the road 70.

The plural vehicles 12 include the leading vehicle 14 traveling at the head of the predefined vehicle formation 74 (see FIG. 10), and the following vehicles 15 traveling behind the leading vehicle 14. The leading vehicle 14 and the following vehicles 15 each include a vehicle controller device 82.

The vehicle controller device 82 of the second exemplary embodiment differs in part from the vehicle controller device 20 of the first exemplary embodiment, and does not perform direct communication using vehicle-to-vehicle communication N2.

The detection device 90 detects the predefined vehicle formation 74 (see FIG. 10) based on the plural vehicles 12 traveling along the road 70. The detection device 90 also detects a currently occurring congestion situation based on the plural vehicles 12 traveling along the road 70. The detection device 90 is, for example, attached to a frame 86 extending upward at a side of the road 70. Although not illustrated in the drawings, plural of the detection devices 90 are installed at predetermined intervals along the road 70.

Detection Device

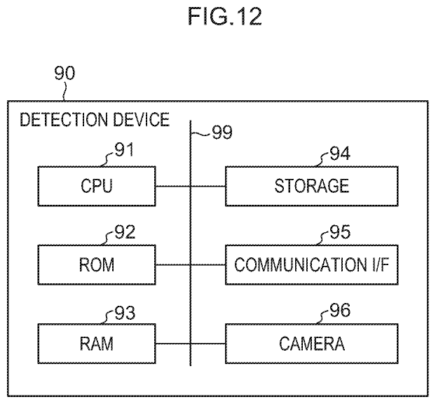

FIG. 12 is a block diagram illustrating hardware configuration of equipment installed in the detection device 90.

As illustrated in FIG. 12, the detection device 90 is configured including a CPU 91, ROM 92, RAM 93, storage 94, a communication I/F 95, and a camera 96. The CPU 91, the ROM 92, the RAM 93, the storage 94, the communication I/F 95, and the camera 96 are connected together so as to be capable of communicating with each other through a bus 99. Functionality of the CPU 91, the ROM 92, the RAM 93, the storage 94, and the communication I/F 95 matches that of the CPU 21, the ROM 22, the RAM 23, the storage 24, and the communication I/F 25 of the vehicle controller device 20 of the first exemplary embodiment.

The CPU 91 reads a program from the ROM 92 or the storage 94, and executes the program, using the RAM 93 as a workspace. In the second exemplary embodiment, a travel program is stored in the ROM 92. The camera 96 images the plural vehicles 12 traveling within a predetermined range on the road 70.

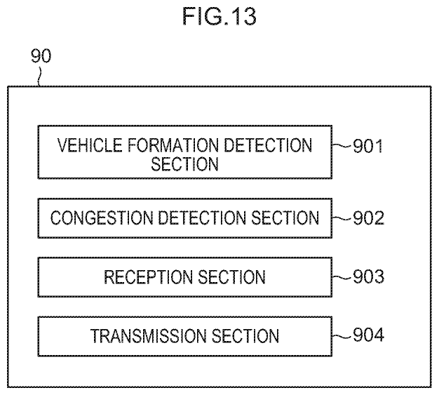

FIG. 13 is a block diagram illustrating an example of functional configuration of the detection device 90.

As illustrated in FIG. 13, the detection device 90 includes a vehicle formation detection section 901, a congestion detection section 902, a reception section 903, and a transmission section 904. The vehicle formation detection section 901, the congestion detection section 902, the reception section 903, and the transmission section 904 are implemented by the CPU 91 reading and executing the travel program stored in the ROM 92 or the storage 94.

The vehicle formation detection section 901 detects a predefined vehicle formation 74 (see FIG. 10) based on the plural vehicles 12 traveling along the road 70.

The congestion detection section 902 detects a currently occurring congestion situation based on the plural vehicles 12 traveling along the road 70.

The reception section 903 receives environmental information from the plural vehicles 12 over the network N1.

The transmission section 904 transmits environmental information to the server device 18 over the network N1. For example, detection signals relating to the predefined vehicle formation 74 detected by the vehicle formation detection section 901 are transmitted from the transmission section 904 to the server device 18 over the network N1. Detection signals relating to the currently occurring congestion situation detected by the congestion detection section 902 are also transmitted from the transmission section 904 to the server device 18 over the network N1.

Control Flow

Explanation follows regarding operation of the travel system 80. Note that operation is explained in order of time, such that operation of the detection device 90 is followed by operation of the server device 18.

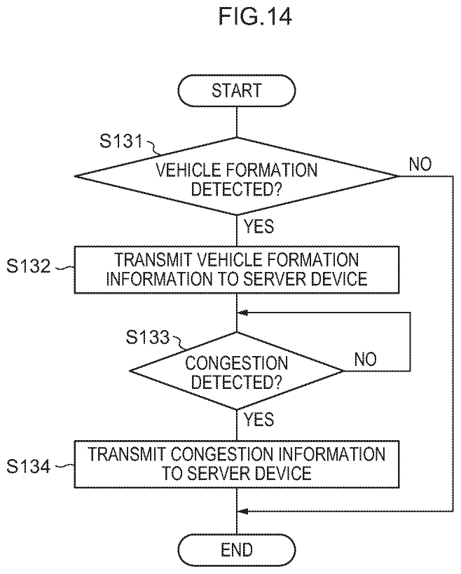

FIG. 14 is a flowchart illustrating a flow of travel processing by the equipment installed in the detection device 90. The CPU 91 reads the travel program from the ROM 92 or the storage 94, expands the travel program in the RAM 93, and executes the travel program in order to perform the travel processing.

At step S131, the CPU 91 determines whether or not a predefined vehicle formation 74 (see FIG. 10) in a traveling state has been detected based on plural vehicles 12 traveling along the road 70. For example, the CPU 91 exchanges information relating to the vehicles 12 that have passed by the respective detection devices 90 through communication between the detection devices 90. The CPU 91 then detects a group of vehicles configured of vehicles 12 between detection devices 90 as a predefined vehicle formation 74 in cases in which the number of vehicles present between these detection devices 90 is a predetermined number or greater. Alternatively, the CPU 91 may detect a chain of vehicles 12 traveling within a predetermined inter-vehicle distance of each other, and detect a group of vehicles configured of these detected vehicles 12 as a vehicle formation 74.

In cases in which a vehicle formation 74 has been detected (namely, when step S131: YES), at step S132 the CPU 91 transmits information relating to the vehicle formation 74 to the server device 18. In cases in which a vehicle formation 74 has not been detected (namely, when step S131: NO), the CPU 91 ends the processing based on the travel program.

At step S133, the CPU 91 determines whether or not congestion has been detected based on the plural vehicles 12 traveling along the road 70.

In cases in which congestion has not been detected (namely, when step S133: NO), the CPU 91 stands by until congestion is detected. In cases in which congestion has been detected (namely, when step S133: YES), at step S134 the CPU 91 transmits information relating to the congestion to the server device 18. The CPU 91 then ends the processing based on the travel program. Note that in cases in which congestion has not been detected (namely, when step S133: NO), the CPU 91 may end the processing based on the travel program.

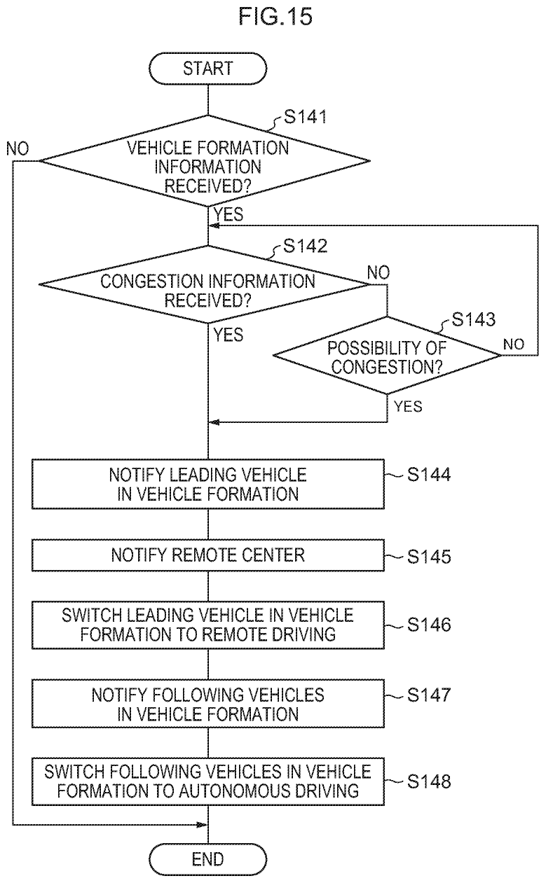

FIG. 15 is a flowchart illustrating a flow of travel processing by the equipment installed in the server device 18. The CPU 41 reads the travel program from the ROM 42 or the storage 44, expands the travel program in the RAM 43, and executes the travel program in order to perform the travel processing.

At step S141, the CPU 41 determines whether or not information relating to a vehicle formation 74 has been received.

In cases in which information relating to a vehicle formation 74 has not been received (namely, when step S141: NO), the CPU 41 ends the processing based on the travel program.

In cases in which information relating to a vehicle formation 74 has been received (namely, when step S141: YES), at step S142 the CPU 41 determines whether or not information relating to congestion has been received. The currently occurring congestion situation is acquired by receiving this information relating to congestion.

In cases in which information relating to congestion has not been received (namely, when step S142: NO), at step S143 the CPU 41 determines whether or not there is a possibility of congestion. In cases in which there is a possibility of congestion (namely, when step S143: YES), the CPU 41 proceeds to the processing of step S144. In cases in which there is a possibility of congestion, a predicted congestion situation is acquired.

In cases in which there is no possibility of congestion (namely, when step S143: NO), the CPU 41 returns to the processing of step S142.

In cases in which information relating to congestion has been received (namely, when step S142: YES), or in cases in which there is a possibility of congestion (namely, when step S143: YES), at step S144 the CPU 41 notifies the leading vehicle 14 configuring the vehicle formation 74 of the currently occurring congestion situation or the predicted congestion situation.

At step S145, the CPU 41 notifies the remote operation station 16 provided at the remote center 17 of the currently occurring congestion situation or the predicted congestion situation.

At step S146, the CPU 41 switches the leading vehicle 14 configuring the vehicle formation 74 over to remote driving. Remote driving of the leading vehicle 14 by the remote operation station 16 is thus started.

At step S147, the CPU 41 notifies each of the following vehicles 15 traveling behind the leading vehicle 14 in the vehicle formation 74 of the currently occurring congestion situation or the predicted congestion situation.

At step S148, the CPU 41 switches each of the following vehicles 15 traveling behind the leading vehicle 14 in the vehicle formation 74 over to autonomous driving. Autonomous driving of the following vehicles 15 is thus started. After the processing of step S148, the CPU 41 ends the processing based on the travel program.

In the travel system 80 described above, the detection devices 90 provided to the road 70 are capable of acquiring information relating to a vehicle formation of traveling vehicles 12 and a currently occurring congestion situation at an early stage. The travel system 80 thereby enables congestion to be alleviated at an early stage when plural vehicles 12 are traveling in comparison to cases in which travel of a leading vehicle and travel of each of the following vehicles in a vehicle formation is left to the drivers of the respective vehicles.

Explanation has been given regarding the travel systems of the first and second exemplary embodiments. However, the present disclosure is not limited to the above exemplary embodiments. Various modifications or improvements thereto may be implemented.

In the travel systems 10, 80 of the first and second exemplary embodiments, the following vehicles 15 traveling behind the leading vehicle 14 in the vehicle formation 74 are switched over to autonomous driving. However, the following vehicles 15 do not need to be switched over to autonomous driving.

Although the travel system 80 of the second exemplary embodiment is provided with the detection devices 90 that acquire information relating to the predefined vehicle formation and a currently occurring congestion situation, the present disclosure is not limited thereto. The travel system may employ the detection devices 90 in conjunction with the vehicle-to-vehicle communication N2. This enables information relating to the predefined vehicle formation and a currently occurring congestion situation to be acquired by the detection devices 90 and through vehicle-to-vehicle communication N2.

Note that the travel processing executed by the CPUs 21, 41, 51, and 91 reading software (for example programs) in the exemplary embodiments described above may be executed by various processors other than CPUs. Examples of such processors include programmable logic devices (PLDs) such as field-programmable gate arrays (FPGAs) that have a circuit configuration that can be modified following manufacture, or dedicated electrical circuits, these being processors such as application specific integrated circuits (ASICs) that have a custom designed circuit configuration to execute specific processing. The travel processing may be executed using one of these processors, or may be executed by a combination of two or more processors of the same type or different types to each other (for example a combination of plural FPGAs, or a combination of a CPU and an FPGA). A more specific example of a hardware structure of these various processors is electric circuitry combining circuit elements such as semiconductor elements.

The exemplary embodiments described above describe a format in which the travel programs are stored (for example installed) in advance in the ROMs 22, 42, 52, and 92 or in the storage 24, 44, 54, and 94. However, there is no limitation thereto. The programs may be provided in a format recorded on a non-transitory recording medium such as compact disc read only memory (CD-ROM), digital versatile disc read only memory (DVD-ROM), or universal serial bus (USB) memory. Alternatively, the programs may be configured in a format to be downloaded from an external device through a network.

The disclosure of Japanese Patent Application No. 2019-133728, filed on Jul. 19, 2019, is incorporated in its entirety by reference herein.

All cited documents, patent applications, and technical standards mentioned in the present specification are incorporated by reference in the present specification to the same extent as if each individual cited document, patent application, or technical standard was specifically and individually indicated to be incorporated by reference.

What is claimed is:

1. A travel control device comprising:
a congestion situation acquisition section configured to acquire a currently occurring congestion situation for traveling vehicles or a predicted congestion situation of predicted congestion for traveling vehicles;
a vehicle formation acquisition section configured to acquire information relating to a predefined vehicle formation in a traveling state;
a communication section configured to communicate with vehicles configuring the vehicle formation; and
a switchover control section configured to switch a leading vehicle traveling at a head of the vehicle formation acquired by the vehicle formation acquisition section over to remote driving when the currently occurring congestion situation or the predicted congestion situation has been acquired by the congestion situation acquisition section.

2. The travel control device of claim 1, further comprising a storage section configured to store a predetermined situation in which congestion is likely to occur as the predicted congestion situation.

3. The travel control device of claim 2, wherein a predetermined disaster is stored in the storage section as the predetermined situation.

4. The travel control device of claim 2, wherein a predetermined location where congestion is likely to occur and a time when congestion is likely to occur are stored in the storage section as the predetermined situation.

5. The travel control device of claim 1, further comprising an autonomous driving switchover control section configured to switch a plurality of following vehicles traveling behind the leading vehicle in the vehicle formation over to autonomous driving.

6. A travel system comprising:
the travel control device of claim 1;
a remote center configured to transmit control information for performing remote driving to the leading vehicle traveling at the head of the vehicle formation; and
a remote driving control section provided at the leading vehicle in order to execute the remote driving based on the control information received from the remote center.

7. A travel system comprising:
the travel control device of claim 5;
a remote center configured to transmit control information for performing remote driving to the leading vehicle traveling at the head of the vehicle formation;
a remote driving control section provided at the leading vehicle in order to execute the remote driving based on the control information received from the remote center; and
an autonomous driving control section provided at a given vehicle of the plurality of following vehicles to control acceleration, deceleration, and steering of the given vehicle by communicating with other vehicles configuring the vehicle formation.

8. The travel system of claim 6, wherein:
a vehicle formation detection section configured to detect the vehicle formation is provided at a road on which the vehicles are traveling; and
the vehicle formation acquisition section is configured to acquire information relating to the vehicle formation derived from a detection signal detected by the vehicle formation detection section.

9. The travel system of claim 6, wherein:
a congestion detection section configured to detect the currently occurring congestion situation is provided at a road on which the vehicles are traveling; and
the congestion situation acquisition section is configured to acquire the currently occurring congestion situation derived from a detection signal detected by the congestion detection section.

10. The travel system of claim 6, wherein the vehicle formation acquisition section is configured to acquire information relating to the vehicle formation from environmental information acquired by communication between the plurality of traveling vehicles.

11. The travel system of claim 6, wherein the congestion situation acquisition section is configured to acquire the currently occurring congestion situation from environmental information acquired by communication between the plurality of traveling vehicles.

12. A travel program executable by a computer to perform processing, the processing comprising:
a step of acquiring a currently occurring congestion situation for traveling vehicles or a predicted congestion situation of predicted congestion for traveling vehicles;
a step of acquiring information relating to a predefined vehicle formation in a traveling state; and
a step of switching a leading vehicle traveling at a head of the vehicle formation over to remote driving when the currently occurring congestion situation or the predicted congestion situation has been acquired.

13. A travel control device comprising:
memory; and
a processor connected to the memory, wherein
the processor is configured to:
acquire a currently occurring congestion situation for traveling vehicles or a predicted congestion situation of predicted congestion for traveling vehicles;
acquire information relating to a predefined vehicle formation in a traveling state; and
switch a leading vehicle traveling at a head of the vehicle formation over to remote driving when the currently occurring congestion situation or the predicted congestion situation has been acquired.
